(19) United States
(12) Patent Application Publication
(10) Pub. No.: US 2026/0141494 A1
(43) Pub. Date: May 21, 2026

(54) CIRRUS IMAGE GENERATION METHOD BASED ON UNCLASSIFIED GUIDANCE

(71) Applicants: Harbin Institute of Technology, Harbin (CN); Southwest University of Science and Technology, Mianyang (CN)

(72) Inventors: Liguo TAN, Harbin (CN); Xu CHU, Harbin (CN); Bin WANG, Harbin (CN); Jianwen HUO, Harbin (CN); Yuehua MENG, Harbin (CN); Gangyin TIAN, Harbin (CN); Debiao LI, Harbin (CN)

(21) Appl. No.: 19/448,877

(22) Filed: Jan. 14, 2026

(30) Foreign Application Priority Data
Jan. 17, 2025 (CN) 202510075707.7

(51) Int. Cl. G06T 5/70; G06T 5/60

(52) U.S. Cl. CPC G06T 5/70; G06T 5/60; G06T 2207/10036; G06T 2207/20081

(57) ABSTRACT

Disclosed is a cirrus image generation method that solves the problem that remote sensing image dehazing datasets are not real and the number of cirrus image features is limited. The present disclosure includes: Obtaining real cirrus images, preprocessing; using a forward process diffusion, constructing a Markov chain, and adding random noise gradually to the cirrus image of the cirrus image dataset. A training dataset is constructed according to the pure noise image and the corresponding real noise. Taking the pure noise image as the input and the corresponding noise as the output, a noise prediction model is established, and the training dataset is used for training, by inputting the randomly generated noise image into the trained noise prediction model, and combining the predicted noise with posterior probability to perform reverse denoising on the image. After a set number of denoising steps, a cirrus image is obtained with real cirrus features.

### TECHNICAL FIELD

The present disclosure relates to a cirrus image generation method based on unclassified guidance, which belongs to the field of image generation technology.

### BACKGROUND

In recent years, the rapid advancement of generative models has led to the emergence of numerous high-quality image generation systems, with DALL⋅E, MidJourney, and Stable Diffusion standing out as notable representatives. These models have demonstrated powerful generative capabilities in areas such as artistic creation, virtual reality, and medical image analysis, driving the widespread application and continuous innovation of image generation technology. However, in the field of remote sensing imagery, particularly in remote sensing image dehazing research, the application of such technologies remains relatively limited, and there is still a shortage of high-quality datasets. The absence of a unified open-source dataset has significantly constrained the development and research of remote sensing image dehazing algorithms.

Currently, some researchers have achieved the synthesis of realistic non-uniform hazy remote sensing images by leveraging the wavelength dependence and spatial variation features of haze. Nevertheless, these methods typically rely on fixed cirrus images for synthesis, resulting in generated dehazing datasets that lack diversity and realism. Moreover, the limited feature variation in the cirrus images cannot adequately meet the learning demands of deep learning models, which require large-scale and diverse data for effective training.

### SUMMARY

Aiming at the problem that the remote sensing image dehazing dataset is not real and the number of cirrus image features is limited, the present disclosure provides a cirrus image generation method based on no classification guidance.

The present disclosure provides a cirrus image generation method based on unclassified guidance, including:
Step 1, obtaining a real cirrus image;
Step 2, preprocessing an obtained real cirrus image to obtain a cirrus image dataset;
Step 3, constructing a Markov chain by using a forward process diffusion, and adding a random noise obeying a Gaussian distribution gradually to a cirrus image of the cirrus image dataset, so that the cirrus image is added to a pure noise image, and constructing a training dataset according to the pure noise image and a corresponding real noise;
Step 4, constructing a noise prediction model by using the pure noise image as input and the corresponding noise as output, and training the noise prediction model by using the training dataset;
Step 5, inputting a randomly generated noise image into a trained noise prediction model, combining a predicted noise with a posterior probability to perform a reverse denoising on the image, after a set number of denoising steps, obtaining a cirrus image with real cirrus features.

In some embodiments, in Step 1, a real cirrus image of an aerosol band with a spectral range of 1.360 to 1.390 microns is obtained.

In some embodiments, in Step 2, preprocessing the obtained real cirrus image, including:

Cropping each real cirrus image, and filtering a cropped image to screen out an image with clear cirruss and obvious features, normalizing a filtered image X to obtain a preprocessed cirrus image x₀.

$${x}_{0} = \frac{( \frac{X}{65535} - 0.5 )}{0.5} .$$

In some embodiments, in Step 3, adding the random noise obeying the Gaussian distribution gradually to the cirrus image of the cirrus image dataset, xₜ denotes a cirrus image after t-step noise addition, the noise addition process is as follows:

$$q ( {x}_{t} \vert {x}_{0} ) = N ( {x}_{t} ; \sqrt{{\overline{α}}_{t}} {x}_{0} , ( 1 - {\overline{α}}_{t} ) I )$$

where x₀ denotes a pre-processed cirrus image, xₜ₋₁ denotes a previous noisy cirrus image, q(xₜ|x₀) denotes a probability of obtaining xₜ under a given premise of x₀ obeys the Gaussian distribution, I denotes a unit matrix, N (·) denotes a Gaussian distribution,

$${\overline{α}}_{t} := {\prod }_{s = 1}^{t} {α}_{s} , {α}_{t} := 1 - {β}_{t} , {β}_{t}$$

denotes a variance of a t-th forward process.

In some embodiments, the noise prediction model adopts a UNet network architecture and combines a linear focusing self-attention mechanism, an output of each position of the linear focusing self-attention mechanism is as follows:

$${O}_{i} = \frac{ϕ ( {Q}_{i} ) ( {\sum }_{j = 1}^{N} {ϕ ( {K}_{j} )}^{T} {V}_{j} )}{ϕ ( {Q}_{i} ) ( {\sum }_{j = 1}^{N} {ϕ ( {K}_{j} )}^{T} )}$$

where Qᵢ denotes an i-th vector in a query matrix Q, Kⱼ denotes a j-th vector in a key matrix K, Vⱼ denotes a j-th vector in a value matrix, N denotes a spatial dimension, a self-attention function

$${ϕ}_{p} ( x ) = {f}_{p} ( R e L U ( x ) ) , {f}_{p} ( x ) = \frac{▯ x ▯}{▯ {x}^{** p} ▯} {x}^{** p} ,$$

x is Qᵢ or Kⱼ, ReLU(·) denotes an activation function, and x^{**p} denotes a p-th power of each element in x.

In some embodiments, the noise predicted by the noise prediction model is as follows:

$${\overline{ò}}_{θ} = ( w + 1 ) {ò}_{θ} ( {x}_{t} , y ) - w {\overline{ò}}_{θ} ( {x}_{t} )$$

where w is a guidance weight, it is used to control a balance between a fidelity and a diversity of a generated image, ò_{θ}(xₜ, y) is a Gaussian noise predicted by containing category information, and ò_{θ}(xₜ) is a noise predicted by not containing the category information.

In some embodiments, a predicted noise combined with a posterior probability to perform reverse denoising on the cirrus image is as follows:

$${x}_{t - 1} = \sqrt{{\overline{α}}_{t - 1}} ( \frac{{x}_{t} - \sqrt{1 - {\overline{α}}_{t}} {\overline{ò}}_{θ}}{\sqrt{{\overline{α}}_{t}}} ) + \sqrt{1 - {\overline{α}}_{t - 1} - \frac{1 - {\overline{α}}_{t - 1}}{1 - {\overline{α}}_{t}} {β}_{t}} {\overline{ò}}_{θ} + \sqrt{\frac{1 - {\overline{α}}_{t - 1}}{1 - {\overline{α}}_{t}} {β}_{t}} ò$$

where xₜ₋₁ denotes a cirrus image obtained after a current reverse denoising, xₜ denotes a cirrus image obtained after a last reverse denoising, T is a maximum number of reverse denoising, βₜ and T are the hyperparameters,

$${α}_{t} := 1 - {β}_{t} , {\overline{α}}_{t} := {\prod }_{s = 1}^{t} {α}_{s} ,$$

o̅_̅{̅θ̅}̅ denotes a predicted noise, ò denotes N (0,I) it is a random noise term sampled from a standard normal distribution.

In some embodiments, the method also includes:
Step 6, based on the obtained cirrus image, synthesizing a remote sensing image dehazing dataset containing real cirrus features:

Based on an atmospheric scattering model, synthesizing a real hazy remote sensing image on a remote sensing image without haze according to a generated cirrus image, a haze synthesis model of a visible light channel j is as follows:

$${I}_{j} ( x ) = {J}_{j} ( x ) {{t}_{1} ( x )}^{{( \frac{{λ}_{1}}{{λ}_{j}} )}^{γ ( x )}} + {A}_{j} ( 1 - {{t}_{1} ( x )}^{{( \frac{{λ}_{1}}{{λ}_{j}} )}^{γ ( x )}} )$$

Iⱼ(x) denotes a real remote sensing image with haze, Jⱼ(x) denotes a remote sensing image without haze, λ₁ denotes a central wavelength of a reference channel 1, λⱼ is a central wavelength of the channel j, Aⱼ denotes a global atmospheric light value;
t₁(x) denotes a haze transmittance, t₁(x)=1−ωρ₉(x) and ρ₉(x) denotes a haze reflectance of a channel 9, namely, the obtained cirrus image. ω∈[0,1] denotes a haze concentration;
γ(x)=a₃(ωρ₉(x))³+a₂(ωρ₉(x))²+a₁(ωρ₉(x)+a₀, a₀, a₁, a₂, and a₃ are coefficients.

The beneficial effect of the present disclosure is that the present disclosure captures the complex spatial structure and optical features of the cirrus image by using the diffusion model, and then generates realistic and diverse cirrus images, thereby constructing a remote sensing image dehazing dataset with rich features. This can not only significantly improve the quality and scale of the dataset, but also provide a unified evaluation standard for the remote sensing image dehazing algorithm, and further promote the development of remote sensing image dehazing technology.

### BRIEF DESCRIPTION OF THE DRAWINGS

FIG. 1 is a flow chart of the present disclosure method;

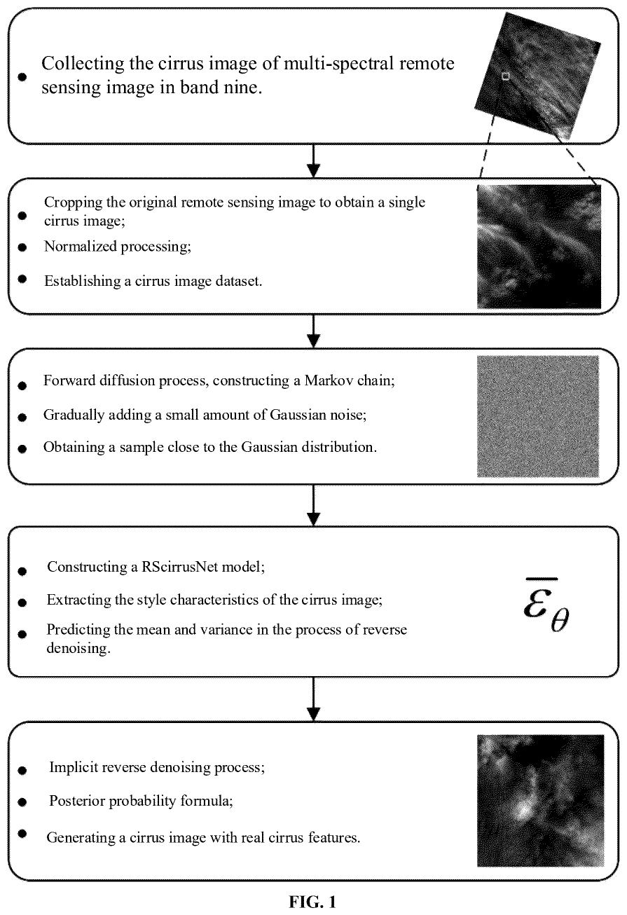

FIG. 2 is a forward process of the unclassified directed diffusion model;

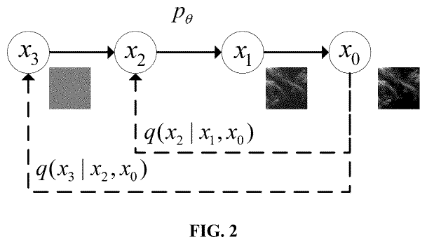

FIG. 3 is a reverse denoising process of the unclassified guided diffusion model.

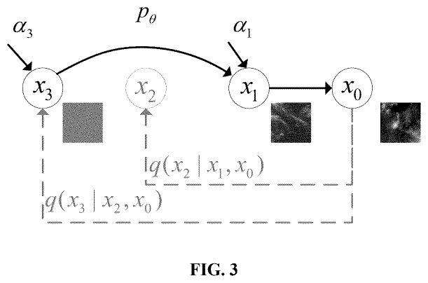

FIG. 4 is a cirrus image generated by the unclassified guided diffusion model;

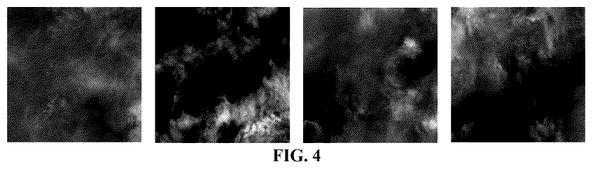

FIG. 5 is a remote sensing image dehazing dataset based on the cirrus image.

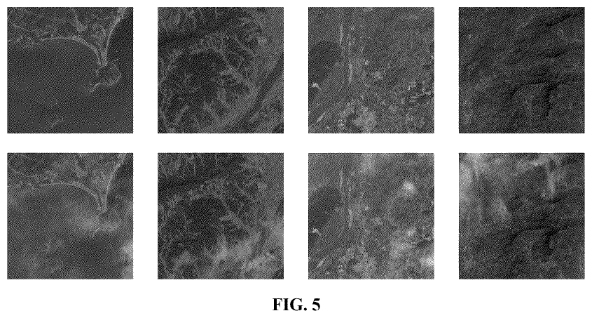

### DETAILED DESCRIPTION OF THE EMBODIMENTS

The following is a further explanation of the present disclosure in combination with the accompanying drawings and specific implementation examples, but it is not a limitation of the present disclosure.

The cirrus image generation method based on a unclassified guidance in this implementation method includes:

Step 1: The real cirrus image is obtained;
specifically, on the Earth Explorer website, the longitude and latitude positions of 100 different centers around the world are selected. Then, the eligible Landsat 8 Earth observation satellite Level-1 data are selected, and the real cirrus image in band nine with a spectral range of 1.360 to 1.390 microns in multispectral remote sensing images are downloaded.

Step 2: The obtained real cirrus image is preprocessed to obtain the cirrus image dataset;
specifically, each cirrus image is cropped to a 512×512 standard cirrus image. Then the images are screened to select the images with clear cirruss and obvious features. Then, the filtered image X is further normalized to the interval of [−1,1], and the pre-processed cirrus image x₀ is obtained. The specific normalization process is calculated by the following formula:

$${x}_{0} = \frac{( \frac{X}{65535} - 0.5 )}{0.5}$$

Finally, all the normalized data are saved and a cirrus image dataset is constructed.

Step 3, the Markov chain is constructed by using the forward process diffusion, and the random noise obeying the Gaussian distribution is gradually added to the cirrus image of the cirrus image dataset, so that it is gradually degraded, and the cirrus image is added to the pure noise image. Finally, the pure noise image close to the Gaussian distribution is generated, and the training dataset is constructed according to the pure noise image and the corresponding real noise. Here, the diffusion step t is set to 1000, x₀ is used to represent the original real cirrus image, xₜ is used to represent the image after t-step noise addition, and the noise addition process is expressed as follows:

$$q ( {x}_{1 : T} \vert {x}_{0} ) := {\prod }_{t = 1}^{T} q ( {x}_{t} \vert {x}_{t - 1} ) , q ( {x}_{t} \vert {x}_{t 1} ) := N ( {x}_{t} ; \sqrt{1 - {β}_{t}} {x}_{t - 1} , {β}_{t} I )$$

The variance βₜ of the forward process uses the interpolation result of the maximum variance βₜ_{ₘₐₓ} and the minimum variance βₜ_{ₘᵢₙ}, the calculation formula is as follows:

$${β}_{t} = exp ( v log {β}_{{t}_{min}} + ( 1 - v ) log {β}_{{t}_{max}} )$$

where v is the scale factor, it is set to 0.3. In addition, a significant feature of the forward process is that xₜ can be sampled in a closed form at any time step t, using the marks

$${α}_{t} := 1 - {β}_{t} and {\overline{α}}_{t} := {\prod }_{s = 1}^{t} {α}_{s} ,$$

so there is:

$$q ( {x}_{t} \vert {x}_{0} ) = N ( {x}_{t} ; \sqrt{{\overline{α}}_{t}} {x}_{0} , ( 1 - {\overline{α}}_{t} ) I )$$

Namely, the probability of obtaining xₜ under the premise of a given x₀ obeys the Gaussian distribution, the mean of the Gaussian distribution is \sqrt{α̅ₜ}, the variance is (1−αₜ)I, and I denotes the unit matrix. When t=T, x_{T} is the pure Gaussian noise, T is the maximum number of noise additions.

Step 4: The noise prediction model is established by using the pure noise image as input and the corresponding noise as output, and the noise prediction model is trained by using the training dataset.

The noise prediction model predicts the noise of the final generated samples close to the Gaussian distribution. The noise prediction model of this implementation method can be implemented by the RSCirrusNet model, and the RSCirrusNet model is used to generate the same size prediction noise as the original cirrus image. The RSCirrusNet model of this implementation method adopts the UNet network architecture and combines the linear focusing self-attention mechanism. Compared with the traditional self-attention mechanism, the linear focusing self-attention mechanism adopted by the RSCirrusNet model in this implementation reduces the computational complexity from O(N²) to O(N), namely, the approximate value of the original similarity function is adopted:

$$Sim ( Q , K ) = ϕ ( Q ) {ϕ ( K )}^{T}$$

$$where :$$

$${ϕ}_{p} ( x ) = {f}_{p} ( R e L U ( x ) ) , {f}_{p} ( x ) = \frac{▯ x ▯}{▯ {x}^{** p} ▯} {x}^{** p}$$

ReLU(·) denotes the ReLU activation function, x^{**p} denotes p-th power of each element in x. The power exponent p can change and adjust the feature direction of each query matrix and key matrix, so that the similar query-key pairs are closer and the features are more obvious. Meanwhile, the dissimilar query-key pairs are pushed away to reduce the feature similarity. Thus, the sharp attention distribution of the original Softmax function is restored.

It can be seen that the feature direction of each query matrix Q and key matrix K can be changed and adjusted in this way, so that the similar query-key pairs are closer and the features are more obvious. Meanwhile, the dissimilar query-key pair is pushed away to reduce the feature similarity.

Further, the self-attention mechanism can be rewritten as:

$${O}_{i} = {\sum }_{j = 1}^{N} \frac{ϕ ( {Q}_{i} ) {ϕ ( {K}_{j} )}^{T}}{{\sum }_{j = 1}^{N} ϕ ( {Q}_{i} ) {ϕ ( {K}_{j} )}^{T}} {V}_{j}$$

Qᵢ denotes the i-th vector in the query matrix, Kⱼ denotes the j-th vector in the key matrix K, Vⱼ denotes the j-th vector in the value matrix, N denotes the spatial dimension, x is Qᵢ or Kⱼ.

In this way, according to the correlation properties of matrix multiplication, the calculation order can be changed from (QK^{T})V to Q(K^{T}V):

$${O}_{i} = \frac{ϕ ( {Q}_{i} ) ( {\sum }_{j = 1}^{N} {ϕ ( {K}_{j} )}^{T} {V}_{j} )}{ϕ ( {Q}_{i} ) ( {\sum }_{j = 1}^{N} {ϕ ( {K}_{j} )}^{T} )}$$

At this time, the marked computational complexity is reduced to O(N).

In addition, another important factor limiting the ability of linear attention expression is the diversity of features, the traditional Transformer self-attention mechanism calculation process, the attention matrix can reach full rank. In the case of linear attention, due to the limitation of channel dimension d, that is:

$$rank ( ϕ ( Q ) {ϕ ( K )}^{T} ) \leq min \{ rank ( ϕ ( Q ) ) , rank ( ϕ ( K ) ) \leq min \{ N , d \} ,$$

where in visual problems, d denotes the channel dimension, d is usually much smaller than N. It shows that the upper bound of the rank of the attention matrix is limited by the lower channel dimension d, which indicates that many rows of the attention map are severely homogenized. In order to improve this situation, a simple and effective solution is adopted to solve this limitation of linear attention, that is, a deep convolution branch is added when calculating self-attention. At this point, the output can be expressed as:

$$O = ϕ ( Q ) {ϕ ( K )}^{T} V + DWC ( V )$$

It can be further expressed as:

$$O = ( ϕ ( Q ) {ϕ ( K )}^{T} + {M}_{DWC} ) V = {M}_{eq} V$$

Since M_{DWC} may be a full rank matrix, this will effectively improve the upper bound of the rank of the attention matrix, that is, the feature diversity of the self-attention module is improved.

When the RSCirrusNet model is built, the training set is used for training, and the sample xₜ after adding noises, time step and category embedding information are input into the RSCirrusNet model, and the current prediction noise can be obtained. For the diffusion model with classification guidance, the Bayesian theorem can be used to logarithmically decompose the conditional generation probability to obtain:

$${∇}_{{x}_{t}} log p ( {x}_{t} \vert y ) = {∇}_{{x}_{t}} log p ( {x}_{t} ) + {∇}_{{x}_{t}} log p ( y \vert {x}_{t} )$$

It can be seen that the first part on the right side of the equation denotes the unclassified information gradient generated by the RSCirrusNet model, while the second part denotes the gradient of the classifier model. Since this implementation method adopts a diffusion model without classification guidance, that is, no additional classification model is needed, ∇ₓ_{ₜ} log p(y|xₜ) should be further decomposed. Firstly, according to the Bayesian formula:

$$p ( y \vert {x}_{t} ) = \frac{p ( {x}_{t} \vert y ) p ( y )}{p ( {x}_{t} )}$$

Then, because xₜ is not included in p(y), it can be decomposed into:

$${∇}_{{x}_{t}} log p ( y \vert {x}_{t} ) = {∇}_{{x}_{t}} log p ( {x}_{t} \vert y ) - {∇}_{{x}_{t}} log p ( {x}_{t} )$$

The gradient is brought into the gradient guided by the classifier, the following can be obtained:

$$\overline{{o}_{θ}} ( {x}_{t} , y ) = ( w + 1 ) {ò}_{θ} ( {x}_{t} , y ) - w {ò}_{θ} ( {x}_{t} )$$

where w is a guidance weight, it is set to 1.8. It can be seen that a conditional generation model and an unconditional generation model are needed here, but the two models can be represented by the same model, and only the conditions of the unconditional model need to be left blank when training. Then, a simplified loss evaluation function is established based on the predicted noise and sample noise images output by the RSCirrusNet model:

$${L}_{simple} := {E}_{{x}_{0} , {ò}_{t}} [ - \overline{{o}_{θ}} {‖}^{2} ]$$

The RSCirrusNet model continuously optimizes and adjusts the weight parameters of the model according to the loss function until a convergent prediction model is obtained.

Step 5, the randomly generated noise image is input into the trained noise prediction model. The predicted noise is combined with the posterior probability to perform reverse denoising on the image. After the set number of denoising steps, the cirrus image with real cirrus features is obtained:

According to the chain rule of multivariate conditional probability, Bayesian formula and Gaussian distribution probability density function, the posterior probability distribution is calculated and reverse denoising is performed, the posterior probability distribution calculation formula is as follows:

$${p}_{θ} ( {x}_{t - 1} \vert {x}_{t} , {x}_{0} ) = N ( {x}_{t - 1} ; {\tilde{μ}}_{t} ( {x}_{t} , {x}_{0} ) , {\tilde{β}}_{t} I )$$

xₜ₋₁ denotes the cirrus image obtained after the current reverse denoising, and xₜ denotes the cirrus image obtained after the previous reverse denoising;
furthermore, according to the implicit diffusion model, it can be calculated that xₜ₋₁ is probably obeys the Gaussian distribution with a mean of \tilde{μ}ₜ(xₜ,x₀) and a variance of \tilde{β}ₜI under the premise of randomly generated Gaussian noise images, where:

$${\tilde{μ}}_{t} ( {x}_{t} , {x}_{0} ) = \sqrt{{\overline{α}}_{t - 1}} {x}_{0} + \sqrt{1 - {\overline{α}}_{t - 1} - {σ}^{2}} \frac{{x}_{t} - \sqrt{{\overline{α}}_{t}} {x}_{0}}{\sqrt{1 - {\overline{α}}_{t}}} , {\tilde{β}}_{t} I = {σ}^{2} I , {σ}^{2} = \frac{1 - {\overline{α}}_{t - 1}}{1 - {\overline{α}}_{t}} {β}_{t}$$

The mean value in the above equation is reparameterized, expressed by xₜ, o̅_̅{̅θ̅}̅, and there is:

$${x}_{t - 1} = \sqrt{{\overline{α}}_{t - 1}} ( \frac{{x}_{t} - \sqrt{1 - {\overline{α}}_{t}} \overline{{o}_{θ}}}{\sqrt{{\overline{α}}_{t}}} ) + \sqrt{1 - {\overline{α}}_{t - 1} - \frac{1 - {\overline{α}}_{t - 1}}{1 - {\overline{α}}_{t}} {β}_{t}} \overline{{o}_{θ}} + \sqrt{\frac{1 - {\overline{α}}_{t - 1}}{1 - {\overline{α}}_{t}} {β}_{t}} ò$$

T is the maximum number of inverse de-noising, βₜ and T are hyperparameters,

$${α}_{t} := 1 - {β}_{t} , {\overline{α}}_{t} := {\prod }_{s = 1}^{t} {α}_{s} ,$$

o̅_̅{̅θ̅}̅ denotes the predicted noise, ò denotes N (0,I), it is a random noise term sampled from a standard normal distribution.

By randomly generating noise data, the trained RSCirrusNet model is combined with the posterior probability for reverse denoising, x₀ is obtained after T cycles, the cirrus image with real texture features can be generated.

The primary objective of this implementation method is to synthesize a remote sensing image dehazing dataset using generated cirrus images. Prior to synthesis, two datasets need to be prepared: one consisting of 11,000 clear, haze-free remote sensing images, and another containing 3,000 multispectral remote sensing images of band 9.

Building upon these, cirrus images with realistic texture features are generated using an unclassified guidance-based cirrus image generation method.

Subsequently, based on the obtained cirrus images, a remote sensing image dehazing dataset incorporating authentic cirrus features is synthesized. Currently, the atmospheric scattering model is widely employed for synthesizing hazy remote sensing images, expressed as:

$$I ( x ) = J ( x ) \cdot t ( x ) + A \cdot ( 1 - t ( x ) )$$

where I(x) is the obtained hazy image, J(x) is the corresponding haze-free image, A is the global atmospheric light value, t(x) is the scene transmittance. When the atmosphere is homogeneous, t(x) can be generalized as:

$$t ( x ) = {e}^{- β \cdot d ( x )}$$

Where β is the atmospheric scattering coefficient, d(x) is the scene depth. In multispectral remote sensing images, the actual haze component varies with both wavelength and localized haze conditions. Since the field of view of a remote sensing system typically covers a considerable area, different parts of the scene may experience varying haze intensities. Therefore, the atmospheric scattering coefficient can be expressed as:

$$β ( λ , γ ( x ) ) = {c}_{0} {λ}^{- γ ( x )}$$

where c₀ is a constant, λ is the wavelength of the corresponding channel, and the index γ(x)∈[0,4] denotes the haze condition. At this time, the haze transmittance t(x) can be re-expressed as:

$$t ( x ) = {e}^{- β ( λ , γ ( x ) ) {d}_{0}}$$

In addition, based on the correlation between channels, the haze transmittance of one channel can be designated as a reference value, from which the transmittance of other hazy channels can be derived. Without loss of generality, the first channel may be set as the reference band.

In addition, according to the correlation between channels, the haze transmittance of one channel can be initialized as a reference value, and then the transmittance of other haze channels can be further deduced. Without loss of generality, the first channel can be set as the reference band. According to the linear relationship between ln t(x) and β(λ,γ(x)), can be further obtained.

$${t}_{j} ( x ) = {{t}_{1} ( x )}^{{( \frac{{λ}_{1}}{{λ}_{j}} )}^{γ ( x )}}$$

where λ₁ denotes the central wavelength of the reference channel 1, λⱼ denotes the central wavelength of the channel j, Aⱼ denotes the global atmospheric light value;
at this time, the haze imaging model of the channel j can be expressed as:

$${I}_{j} ( x ) = {J}_{j} ( x ) {{t}_{1} ( x )}^{{( \frac{{λ}_{1}}{{λ}_{j}} )}^{γ ( x )}} + {A}_{j} ( 1 - {{t}_{1} ( x )}^{{( \frac{{λ}_{1}}{{λ}_{j}} )}^{γ ( x )}} )$$

where λⱼ can be directly set to its center wavelength, and the global atmospheric light value A is set to the average intensity of the brightest 0.01% pixels in each channel of the remote sensing image. In addition, because the reflectivity of channel 9, that is, the generated cirrus image with real texture features, can reflect the spatial non-uniformity of the actual haze, it is used to generate the transmission map of channel 1, which is expressed as:

$${t}_{1} ( x ) = 1 - ω {ρ}_{9} ( x )$$

where ρ₉(x) denotes the haze reflectivity of channel 9, that is, the normalized cirrus image, ω∈[0,1] denotes the haze concentration. The larger ω will generate smaller transmission values, corresponding to more serious haze conditions. The last parameter γ(x) of the synthesized haze remote sensing image is used to describe the non-uniform spatial distribution of haze concentration. According to the relationship between the index γ(x) and the haze reflectivity ρ, the cubic curve can be used for fitting, and the formula can be expressed as:

$$γ ( x ) = {{a}_{3} ( ω {ρ}_{9} ( x ) )}^{3} + {{a}_{2} ( ω {ρ}_{9} ( x ) )}^{2} + {a}_{1} ( ω {ρ}_{9} ( x ) ) + {a}_{0}$$

where a₀, a₁, a₂ and a₃ are coefficients, in this implementation method, a₀=6.537, a₁=−27.465, a₂=41.224, and a₃=−21.547. It should be noted that γ(x) should be limited between [0,4] to avoid abnormal values, the present disclosure can synthesize a real hazy remote sensing image Iⱼ from a haze-free remote sensing image Jⱼ through the above parameterization method.

While the present disclosure has been described herein with reference to specific embodiments, it is to be understood that these embodiments serve only as examples to illustrate the principles and applications of the present disclosure. Accordingly, it should be recognized that numerous modifications may be made to the exemplary embodiments, and other arrangements may be devised, without departing from the spirit and scope of the present disclosure as defined by the appended claims. It is understood that various dependent claims and the features described herein may be combined in ways different from those originally set forth in the claims. It is also recognized that features described in connection with one embodiment may be utilized in other described embodiments.

What is claimed is:

1. A cirrus image generation method based on unclassified guidance, comprising:
Step 1, obtaining a real cirrus image;
Step 2, preprocessing an obtained real cirrus image to obtain a cirrus image dataset;
Step 3, constructing a Markov chain by using a forward process diffusion, and adding random noise obeying a Gaussian distribution gradually to a cirrus image of the cirrus image dataset, so that the cirrus image is added to a pure noise image, and constructing a training dataset according to the pure noise image and a corresponding real noise;
Step 4, constructing a noise prediction model by using the pure noise image as input and a corresponding noise as output, and training the noise prediction model by using the training dataset;
Step 5, inputting a randomly generated noise image into a trained noise prediction model, combining a predicted noise with a posterior probability to perform a reverse denoising on the image, and, after a set number of denoising steps, obtaining a cirrus image with real cirrus features;
Step 6, based on the obtained cirrus image, synthesizing a remote sensing image dehazing dataset containing real cirrus features:
based on an atmospheric scattering model, synthesizing a real hazy remote sensing image on a remote sensing image without haze according to the generated cirrus image, wherein a haze synthesis model of a visible light channel j is as follows:
$${I}_{j} ( x ) = {J}_{j} ( x ) {{t}_{1} ( x )}^{{( \frac{{λ}_{1}}{{λ}_{j}} )}^{γ ( x )}} + {A}_{j} ( 1 - {{t}_{1} ( x )}^{{( \frac{{λ}_{1}}{{λ}_{j}} )}^{γ ( x )}} )$$
where Iⱼ(x) denotes a real remote sensing image with haze, Jⱼ(x) denotes a remote sensing image without haze, λ₁ denotes a central wavelength of a reference channel 1, λⱼ is a central wavelength of the channel j, Aⱼ denotes a global atmospheric light value;
t₁(x) denotes a haze transmittance, t₁(x)=1−ωρ₉(x) and ρ₉(x) denotes a haze reflectance of a channel 9, namely, the obtained cirrus image where ω∈[0,1] denotes a haze concentration; and
γ(x)=a₃(ωρ₉(x))³+a₂(ωρ₉(x))²+a₁(ωρ₉(x))+a₀, where a₀, a₁, a₂, and a₃ are coefficients.

2. The cirrus image generation method based on unclassified guidance according to claim 1, wherein in Step 1, a real cirrus image of an aerosol band with a spectral range of 1.360 to 1.390 microns is obtained.

3. The cirrus image generation method based on unclassified guidance according to claim 1, wherein in Step 2, preprocessing the obtained real cirrus image, comprises:
cropping each real cirrus image, and filtering the cropped image to screen out an image with clear cirrus and obvious features, normalizing a filtered image X to obtain a preprocessed cirrus image x₀.
$${x}_{0} = \frac{( \frac{X}{65535} - 0.5 )}{0.5} .$$

4. The cirrus image generation method based on unclassified guidance according to claim 1, wherein in Step 3, adding random noise obeying the Gaussian distribution gradually to the cirrus image of the cirrus image dataset, xₜ denotes a cirrus image after t-step noise addition, the noise addition process is as follows:
$$q ( {x}_{t} \vert {x}_{0} ) = N ( {x}_{t} ; \sqrt{{\overline{α}}_{t}} {x}_{0} , ( 1 - {\overline{α}}_{t} ) I )$$
where x₀ denotes a pre-processed cirrus image, xₜ₋₁ denotes a previous noisy cirrus image, q(xₜ|x₀) denotes a probability of obtaining xₜ under a given premise of x₀ obeys the Gaussian distribution, I denotes a unit matrix, N (·) denotes a Gaussian distribution,
$${\overline{α}}_{t} := {\prod }_{s = 1}^{t} {α}_{s} , {α}_{t} := 1 - {β}_{t} , {β}_{t}$$
denotes a variance of a t-th forward process.

5. The cirrus image generation method based on unclassified guidance according to claim 1, wherein the noise prediction model adopts a UNet network architecture and combines a linear focusing self-attention mechanism, and an output of each position of the linear focusing self-attention mechanism is as follows:
$${O}_{i} = \frac{ϕ ( {Q}_{i} ) ( {\sum }_{j = 1}^{N} {ϕ ( {K}_{j} )}^{T} {V}_{j} )}{ϕ ( {Q}_{i} ) ( {\sum }_{j = 1}^{N} {ϕ ( {K}_{j} )}^{T} )}$$
where Qᵢ denotes an i-th vector in a query matrix Q, Kⱼ denotes a j-th vector in a key matrix K, Vⱼ denotes a j-th vector in a value matrix, N denotes a spatial dimension, a self-attention function
$${ϕ}_{p} ( x ) = {f}_{p} ( ReLU ( x ) ) , {f}_{p} ( x ) = \frac{▯ x ▯}{▯ {x}^{** p} ▯} {x}^{** p} ,$$
x is Qᵢ or Kⱼ, ReLU(·) denotes an activation function, and x^{**p} denotes a p-th power of each element in x.

6. The cirrus image generation method based on unclassified guidance according to claim 5, wherein the noise predicted by the noise prediction model is as follows:
$${\overline{o}}_{θ} = ( w + 1 ) {ò}_{θ} ( {x}_{t} , y ) - w {ò}_{θ} ( {x}_{t} )$$
where w is a guidance weight used to control a balance between a fidelity and a diversity of a generated image, ò_{θ}(xₜ, y) is a Gaussian noise predicted by containing category information, and ò_{θ}(xₜ) is a noise predicted by not containing the category information.

7. The cirrus image generation method based on unclassified guidance according to claim 1, wherein a predicted noise combined with a posterior probability to perform reverse denoising on the cirrus image is as follows:
$${x}_{t - 1} = \sqrt{{\overline{α}}_{t - 1}} ( \frac{{x}_{t} - \sqrt{1 - {\overline{α}}_{t}} \overline{{o}_{θ}}}{\sqrt{{\overline{α}}_{t}}} ) + \sqrt{1 - {\overline{α}}_{t - 1} - \frac{1 - {\overline{α}}_{t - 1}}{1 - {\overline{α}}_{t}} {β}_{t}} \overline{{o}_{θ}} + \sqrt{\frac{1 - {\overline{α}}_{t - 1}}{1 - {\overline{α}}_{t}} {β}_{t}} ò$$
where xₜ₋₁ denotes a cirrus image obtained after a current reverse denoising, xₜ denotes a cirrus image obtained after a last reverse denoising, Tis a maximum number of reverse denoising, βₜ and T are the hyperparameters,
$${α}_{t} := 1 - {β}_{t} , {\overline{α}}_{t} := {\prod }_{s - 1}^{t} {α}_{s} ,$$
o̅_̅{̅θ̅}̅ denotes a predicted noise, ò denotes N (0,I), which is a random noise term sampled from a standard normal distribution.
